(19) United States
(12) Patent Application Publication
(10) Pub. No.: US 2026/0066329 A1
(43) Pub. Date: Mar. 5, 2026

(54) SYSTEM AND METHOD FOR MANUFACTURING SECONDARY BATTERY

(71) Applicant: SAMSUNG SDI CO., LTD., Yongin-si (KR)

(72) Inventors: Daeseong JEONG, Yongin-si (KR); Jiho YANG, Yongin-si (KR); Jushik UHM, Yongin-si (KR)

(21) Appl. No.: 19/220,407

(22) Filed: May 28, 2025

(30) Foreign Application Priority Data
Sep. 5, 2024 (KR) 10-2024-0120966

(51) Int. Cl. H01M 10/04

(52) U.S. Cl. CPC H01M 10/0431; H01M 10/0404

(57) ABSTRACT

A system for manufacturing a secondary battery includes a reform pin insertable into a central hole of an electrode assembly, the electrode assembly including a wound stack of a first electrode, a separator, and a second electrode, a driver configured to move the reform pin and to insert the reform pin into the central hole, after the electrode assembly is embedded in a case, and a rotator configured to rotate the reform pin.

### CROSS-REFERENCE TO RELATED APPLICATION

The present application claims priority to and the benefit of Korean Application No. 10-2024-0120966, filed on Sep. 5, 2024, in the Korean Intellectual Property Office, the entire disclosure of which is incorporated by reference herein.

### BACKGROUND

### 1 Field

The present disclosure relates to a system and method for manufacturing a secondary battery.

### 2. DESCRIPTION OF THE RELATED ART

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Secondary batteries are used in various environments due to their excellent electrical characteristics, but conventional small batteries have limitations in energy density that may be designed. Because the amount of electrical energy that may be stored is limited relative to the size and weight of the battery, a demand for large batteries with greater energy density is gradually increasing in applications such as electric vehicles.

The above information disclosed in this Background section is for enhancement of understanding of the background of the present disclosure, and therefore, it may contain information that does not constitute related (or prior) art.

### SUMMARY

Embodiments of the present disclosure provide a system for manufacturing a secondary battery, including a reform pin inserted into a central hole of an electrode assembly formed by stacking and winding a first electrode, a separator, and a second electrode, a driving portion lowering the reform pin so that the reform pin is inserted into the central hole, and a rotating portion rotating the reform pin, wherein the electrode assembly is embedded in a case before the reform pin is inserted.

The reform pin may include a cylinder portion having a cylindrical shape, a tapered portion formed at one end of the cylinder portion, and a connecting portion connecting the cylinder portion and the tapered portion.

A length of the reform pin inserted into the electrode assembly may be 60% to 95% of that of the electrode assembly.

A length of the reform pin inserted into the electrode assembly may be 60 mm to 70 mm.

A diameter of the reform pin may be 80% to 90% of that of the central hole.

A diameter of the central hole may be 12% to 15% of that of the electrode assembly

A diameter of the reform pin may be 4.26 mm and 4.34 mm.

A length of the tapered portion may be 35% to 45% of that of the electrode assembly.

A length of the tapered portion may be from 28 mm to 32 mm.

The connecting portion may be fillet-processed.

The connecting portion may be fillet-processed with a radius of curvature of 10 mm to 20 mm.

The rotating member may be driven to rotate the reform pin at a speed of 1000 rpm to 1499 rpm.

The rotating portion may be driven to rotate three or more times after the reform pin is inserted into the central hole.

The system for manufacturing the secondary battery may further include a floating sensor portion that measures air pressure inside the case.

A diameter of the case may be 45 mm to 47 mm.

Another embodiment of the present disclosure provides a method for manufacturing a secondary battery, including forming an electrode assembly by stacking and winding a first electrode, a separator, and a second electrode, embedding the electrode assembly into a case, lowering a reform pin and inserting it into a central hole of the electrode assembly, and rotating the reform pin.

The method for manufacturing the secondary battery may further include inserting a terminal welding rod through the central hole of the electrode assembly.

The rotating of the reform pin may include driving a rotating portion to rotate the reform pin at a speed of 1000 rpm to 1499 rpm.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings below.

FIG. 1 illustrates a conceptual diagram of a system for manufacturing a secondary battery according to an embodiment of the present disclosure.

FIG. 2 and FIG. 3 illustrate stages in a process of inserting a reform pin into an electrode assembly according to an embodiment of the present disclosure, respectively.

FIG. 4 illustrates a cross-sectional view of a reform pin according to an embodiment of the present disclosure.

FIG. 5 illustrates an example of a defect in a core portion of an electrode assembly that may occur before reforming.

FIG. 6 illustrates an example of a core portion of an electrode assembly improved according to an embodiment of the present disclosure.

FIG. 7 to FIG. 9 illustrate data of a shortened length of a core portion of an electrode assembly according to an outer diameter of a reform pin according to an embodiment of the present disclosure.

FIG. 10 illustrates a flowchart of an example of a method for manufacturing a secondary battery according to the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain embodiments in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when a layer or element is referred to as being “between” two layers, it can be the only layer between the two layers, or one or more intervening layers may also be present. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components “.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

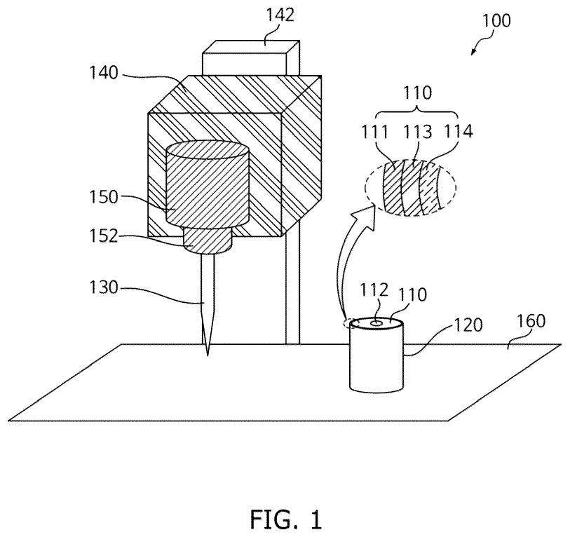

FIG. 1 illustrates a conceptual diagram of a system for manufacturing a secondary battery according to an embodiment of the present disclosure.

Referring to FIG. 1, a system 100 for manufacturing a secondary battery (or a secondary battery manufacturing system 100) according to an embodiment of the present disclosure may include a reform pin 130 inserted (e.g., insertable) into a central hole 112 of an electrode assembly 110 formed by stacking and winding a first electrode 111, a separator 113, and a second electrode 114, a driving portion 140 (e.g., a driver) that lowers the reform pin 130 so that the reform pin 130 is inserted into the central hole 112, and a rotating portion 150 (e.g., a rotator) that rotates the reform pin 130.

The first electrode of the electrode assembly 110 may be an electrode corresponding to a positive electrode or a negative electrode in a secondary battery. The second electrode may be an electrode having a polarity opposite to that of the first electrode. For example, in a case where the first electrode is a positive electrode, the second electrode may be a negative electrode. Conversely, in a case where the first electrode is a negative electrode, the second electrode may be a positive electrode. As an example, the first electrode may be formed as a positive electrode by coating a positive electrode active material on an aluminum (Al) substrate, and the second electrode may be formed as a negative electrode by coating a negative electrode active material on a copper (Cu) substrate.

The outer surface of the electrode assembly 110 may include a substrate layer configuring a separator or an electrode. For example, the outer surface of the electrode assembly 110 may be one end of a separator that extends long from the separator to prevent the active material configuring the first electrode or the second electrode from being exposed to the outside. In another example, the outer surface of the electrode assembly 110 may be one end of a substrate layer formed by extending a non-coated portion of a substrate layer on which an active material configuring the first electrode or the second electrode is not applied.

In the embodiment, the electrode assembly 110 may be formed in a jelly roll state by sequentially winding the first electrode, the separator, and the second electrode. The first electrode and the second electrode may respectively include a coating portion where an active material is respectively coated on both surfaces of a substrate formed of a thin metal plate and a non-coated portion where the substrate is exposed because the active material is not coated thereon. As an example, the first electrode may be formed as a positive electrode by coating a positive electrode active material on an aluminum (Al) substrate, and the second electrode may be formed as a negative electrode by coating a negative electrode active material on a copper (Cu) substrate. The first electrode, the second electrode, and the separator may be impregnated with an electrolyte.

After the jelly roll is wound, the central hole 112 may be disposed at the center of the electrode assembly 110 (e.g., the central hole 112 may extend along the central winding axis of the electrode assembly 110 and along an entire height of the electrode assembly 110). According to an embodiment of the present disclosure, the diameter of the central hole 112 may be 12% to 15% of the diameter of the electrode assembly 110. For example, the diameter of the electrode assembly 110 may be 46 mm, and the diameter of the central hole 112 may be 5.5 mm to 6.9 mm.

According to another embodiment of the present disclosure, the diameter of the central hole 112 may be 8% to 10% of the diameter of the electrode assembly 110. For example, the diameter of the electrode assembly 110 may be 46 mm, and the diameter of the central hole 112 may be 3.7 mm to 4.6 mm.

In one embodiment, the central hole 112 may have an elliptical shape, when viewed in a top view. For example, as the electrode assembly 110 is left for a long time, a portion of the wound jelly roll may be unwound or the separator forming the outer wall of the central hole 112 may be contracted/expanded, and thus the central hole 112 may be deformed into an elliptical shape. In a case where the central hole 112 has an elliptical shape, the major axis of the central hole 112 may have the same size as the diameter described above. In a case where the central hole 112 has an elliptical shape, the short axis of the central hole 112 may be 70% to 100% of the length of the major axis.

Herein, the electrode assembly 110 may be embedded in a case 120 before the reform pin 130 is inserted into the central hole 112. The case 120 may form the overall outer appearance of the secondary battery and may provide a space in which the electrode assembly 110 is accommodated. For example, in a case where the secondary battery is a cylindrical secondary battery, the case 120 may have a cylindrical shape. According to an embodiment of the present disclosure, the diameter of the case 120 may be 45 mm to 47 mm. The case 120 may have a completely open opening to allow insertion of the electrode assembly 110 through one side.

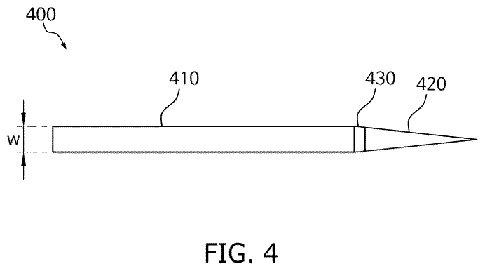

One end of the reform pin 130 according to an embodiment may have a conical shape. This will be described later with reference to FIG. 4.

The driving portion 140 according to an embodiment of the present disclosure may be configured to move the reform pin 130 (e.g., lower the position of the reform pin 130) compared to the fixing portion 142 and the providing portion 160 so that the reform pin 130 is inserted into the central hole 112 (e.g., the driving portion 140 may be vertically movable along the fixing portion 142 in order to vertically move the reform pin 130). For example, the driving portion 140 may include a motor that provides power to move (e.g., to lower and raise) the reform pin 130 along a direction that is vertical (e.g., normal) with respect to the providing portion 160, a screw that converts the rotational motion of the motor into a linear motion of the reform pin 130, and a guide rail or a slide block for stably maintaining the linear motion of the reform pin 130. Herein, the motor may include configurations that may be used to provide general power, e.g., a servo motor, a step motor, or a combination thereof. Herein, the screw may include, e.g., a lead screw, a ball screw, a cylinder, a single-axis robot, or a combination thereof.

The rotating portion 150 according to an embodiment of the present disclosure may be configured to rotate the reform pin 130 at a speed of 1000 rpm to 1499 rpm. In a case where the reform pin 130 is rotated at a speed of 1500 rpm or more, the friction between the reform pin 130 and the central hole 112 excessively increases, and thus the separator forming the outer wall of the central hole 112 may be broken. In a case where the reform pin 130 is rotated at a speed of 1500 rpm or more, a disadvantage result may occur in maintaining the shape of the central hole 112.

In some embodiments, the rotating portion 150 may be driven to rotate three or more times after the reform pin 130 is inserted into the central hole 112. In a case where the reform pin 130 is rotated less than once after being inserted into the central hole 112, it can be confirmed that the effect of reforming the shape of the central hole 112 is insignificant. In a case where the reform pin 130 is rotated three or more times after being inserted into the central hole 112, the effect of reforming the shape of the central hole 112 may be consistently achieved.

The rotating portion 150 may include a motor that is controlled separately from the driving portion 140, and a driving force generated by the motor may be transmitted to the reform pin 130 connected to the rotating portion 150. For example, the rotating portion 150 may perform precise position control of the reform pin 130 by interacting with the driving portion 140 by a control device, e.g., a programmable logic controller (PLC) or a computer numerical control (CNC) system.

According to an embodiment of the present disclosure, the secondary battery manufacturing system 100 may further include a floating sensor portion 152 (e.g., a floating sensor) that measures the air pressure inside the case 120. For example, the floating sensor portion 152 may include a diaphragm sensor for measuring air pressure at one end of the reform pin 130, and a strain gauge or a converter for converting deformation of the diaphragm into an electrical signal. Due to increase of the air pressure measured by the floating sensor portion 152, the controller may determine whether the reform pin 130 is inserted into the central hole 112 of the electrode assembly 110 and transmit an operation signal to the rotating portion 150.

The providing portion 160 (e.g., a provider) according to an embodiment of the present disclosure may perform a function of stably supplying the electrode assembly 110 to a predetermined position and smoothly conveying the electrode assembly 110 to another assembly process after reforming (e.g., the providing portion 160 may be a surface that supports and moves the electrode assembly 110 in a predetermined direction). The providing portion 160 may include a conveyor system, a pick-and-place device, an alignment device, or a combination thereof. The providing portion 160 may include a sensor for monitoring the position and state of the electrode assembly 110 or the reform pin 130. Herein, the sensor may include any suitable sensor, e.g., an optical sensor, an ultrasonic sensor, and a vision sensor.

For description of the present disclosure, the secondary battery (or the electrode assembly 110 embedded in the case 120) is shown as a cylindrical secondary battery in FIG. 1. However, the secondary battery manufactured by the present disclosure may include any suitable type of a secondary battery, e.g., a prismatic secondary battery, a pouch secondary battery, a coin secondary battery, or the like.

According to some embodiments of the present disclosure, by inserting into and rotating the reform pin 130 in the central hole 112 of the electrode assembly 110, it is possible to correct a defect in which the core portion of the electrode assembly 110 wound during the manufacturing process of a secondary battery becomes partially unwound over time or during the process of inserting the wound electrode assembly 110 into the case 120, e.g., rotating the reform pin 130 in the central hole 112 of the electrode assembly 110 may tighten the inner winding of the electrode assembly 110.

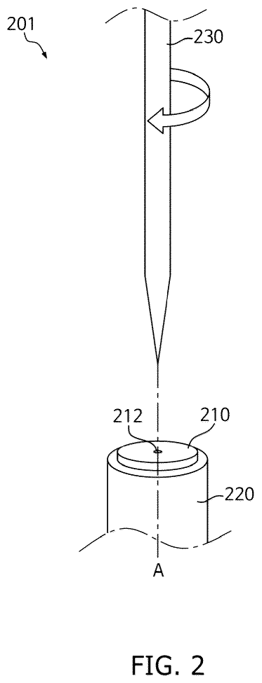

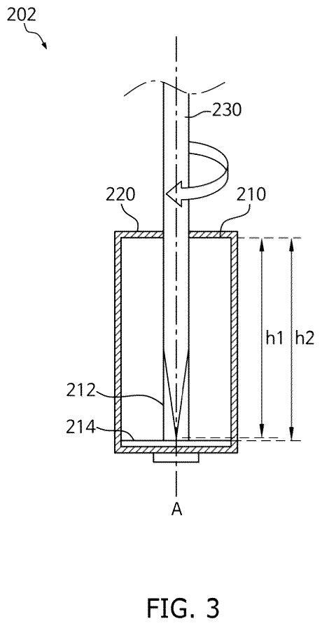

FIG. 2 and FIG. 3 illustrate a process of inserting a reform pin into an electrode assembly according to an embodiment of the present disclosure, respectively.

Referring to FIG. 2, before inserting the reform pin (201), the central axis of the reform pin 230 and the axis of the central hole 212 of the electrode assembly 210 may be aligned on the same line (A). In this case, the electrode assembly 210 may be embedded in the case 220 before the reform pin 230 is inserted.

According to the embodiment, the diameter of the central hole 212 may be 12% to 15% of the diameter of the electrode assembly 210. For example, the diameter of the electrode assembly 210 may be 46 mm, and the diameter of the central hole 212 may be 5.5 mm to 6.9 mm. As another example, the diameter of the electrode assembly 210 may be 44 mm, and the diameter of the central hole 212 may be 5.3 mm to 6.6 mm. As another example, the diameter of the central hole 212 may be 8% to 10% of the diameter of the electrode assembly 210. For example, the diameter of the electrode assembly 210 may be 46 mm, and the diameter of the central hole 212 may be 3.7 mm to 4.6 mm.

Referring to FIG. 3, after inserting the reform pin (202), the central axis of the reform pin 230 and the axis of the central hole 212 of the electrode assembly 210 may be aligned on the same line (A).

According to an embodiment of the present disclosure, the length h1 of the reform pin 230 inserted into the electrode assembly 210 (i.e., the length h1 of the portion of the reform pin 230 inserted into the electrode assembly 210) may be 60% to 95% of the length h2 of the electrode assembly 210. For example, the length h2 of the electrode assembly 210 may be 74 mm, and the length h1 of the reform pin 230 inserted into the electrode assembly 210 may be 60 mm to 70 mm.

For example, the length h1 of the reform pin 230 inserted into the electrode assembly 210 may be shorter than the length h2 of the electrode assembly 210, so that the reform pin 230 may not be in physical contact with the current collector plate 214 existing between the case 220 and the electrode assembly 210. In a case where the length h1 of the reform pin 230 inserted into the electrode assembly 210 is longer than the length h2 of the electrode assembly 210 and the reform pin 230 comes into contact with the current collector plate 214, a defect may occur in which the current collector plate 214 is damaged in the process of rotating the reform pin 230.

As another example, in a case where the length h1 of the reform pin 230 inserted into the electrode assembly 210 is excessively shorter than the length h2 of the electrode assembly 210, the lower core portion of the electrode assembly 210 is not properly reformed (e.g., corrected), so that the effect of defect improvement may be reduced. For example, in a case where the length h2 of the electrode assembly 210 is 74 mm and the length h1 of the reform pin 230 inserted into the electrode assembly 210 is 50 mm or less, the lower core portion of the electrode assembly 210 may not expand even in a case where the reform pin 230 is inserted into the electrode assembly 210 and rotated.

Descriptions of other components are the same as those described above with reference to FIG. 1.

FIG. 4 illustrates a cross-sectional view of a reform pin according to an embodiment of the present disclosure.

Referring to FIG. 4, a reform pin 400 according to an embodiment of the present disclosure may include a cylinder portion 410 having a cylindrical shape, a tapered portion 420 formed at one end of the cylinder portion 410, and a connecting portion 430 connecting the cylinder portion 410 and the tapered portion 420.

The cylinder portion 410 may be a cylindrical rod having the same (e.g., constant) width. The cylinder portion 410 is configured to connect the reform pin 400 and the rotating portion, and may serve to transmit a driving force generated from the rotating portion to the entire reform pin 400. Additionally, the cylinder portion 410 is the thickest portion of the reform pin 400 and may determine the diameter of the entire reform pin 400. The cylinder portion 410 may perform, while the reform pin 400 rotates, the function of reforming (e.g., correcting or adjusting) the central hole of the electrode assembly back into a circular shape by coming into contact with the central hole of the electrode assembly or of rewinding the core portion of the electrode assembly.

According to an embodiment of the present disclosure, the diameter (w) of the reform pin 400, i.e., the diameter of the cylinder portion 410, may be 80% to 90% of the diameter of the central hole of the electrode assembly (e.g., the short axis of an elliptical hole when the central hole of the electrode assembly is deformed).

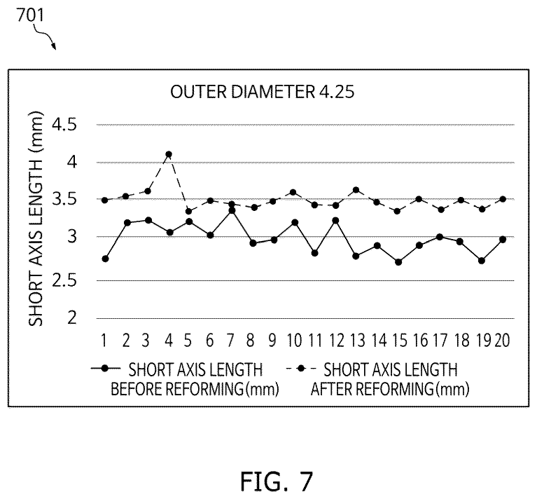

For example, in a case where the diameter (or short axis) of the central hole of the electrode assembly is 4.8 mm, the diameter (w) of the reform pin 400 may be 4.26 mm to 4.34 mm. The specific numerical values and the corresponding effects on the diameter (w) of the reform pin 400 will be described later with reference to FIG. 7 to FIG. 9.

The tapered portion 420 may be a cone including an inclined surface formed in the insertion direction of the reform pin 400. For example, the insertability of the reform pin 400 into the central hole of the electrode assembly may be improved through the inclined surface present in the conical tapered portion 420.

For example, the tapered portion 420 may have a symmetrical conical shape having the same central axis as the cylinder portion 410. Because the electrode assembly is inserted into the case, it is difficult to determine the elliptical direction of the central hole from the external appearance, and because the central hole of the electrode assembly may have an irregular shape and size due to the unwound core portion, the tapered portion 420 may be symmetrical so that the reform pin 400 may enter the central hole even in a situation where the shape, size, and direction of the central hole are not determined.

The tapered portion 420 may be formed at one end of the cylinder portion 410. For example, the tapered portion 420 may be made of the same material as the cylinder portion 410.

According to an embodiment of the present disclosure, the length of the tapered portion 420 may be 35% to 45% of the length of the electrode assembly. For example, in a case where the length of the electrode assembly is 74 mm, the length of the tapered portion 420 may be 28 mm to 32 mm.

In a case where the length of the tapered portion 420 is 35% or less of the length of the electrode assembly, the insertability of the reform pin 400 into the central hole of the electrode assembly may be reduced. For example, in a case where the length of the tapered portion 420 is short, the speed at which air existing in the central hole is discharged decreases as the reform pin 400 is inserted, which increases the internal pressure of the central hole, and this may cause poor winding of the electrode assembly.

In a case where the length of the tapered portion 420 is 45% or more of the length of the electrode assembly, the insertability of the reform pin 400 into the central hole of the electrode assembly may be the same as in a case where the length of the tapered portion 420 is 35% to 45% of the length of the electrode assembly. However, as the length of the tapered portion 420 increases, the length of the cylinder portion 410 inserted into the electrode assembly may decrease. This has the effect of reducing the specific gravity of the cylinder portion 410 that comes into direct contact with the central hole, so that while the reform pin 400 rotates, the effect of reforming the central hole back into a circular shape by coming into contact with the central hole of the electrode assembly or of rewinding the core portion of the electrode assembly may be reduced.

According to an embodiment of the present disclosure, the connecting portion 430 may be fillet-processed, e.g., may have curved edges. Herein, fillet processing may include a milling process to process edges into curves using a computer numerical control (CNC) milling machine, a grinding process to make the surface into a smooth curve using a grinder, a pressing process to press a metal plate into a curved shape, or a combination thereof.

For example, the connecting portion 430 may be fillet-processed with a radius of curvature of 10 mm to 20 mm. In a comparative example, e.g., when the radius of curvature of a connecting portion is 5 mm or less, the insertability of the reform pin may be poor.

As the connecting portion 430 is fillet-processed, a phenomenon in which stress is concentrated during the process of inserting the reform pin 400 into the central hole of the electrode assembly may be alleviated. For example, it is possible to reduce or prevent stress concentration that may inevitably occur at a sharp corner positioned at the linear connecting portion 430 connecting the cylinder portion 410 and the tapered portion 420, each having a straight cross-section.

For example, as the connecting portion 430 is fillet-processed, the appearance of the reform pin 400 may be made beautiful and smooth, and the separator may be prevented from being broken due to the sharp edge positioned in the connecting portion 430. This may reduce the probability of internal short circuits occurring in secondary batteries.

According to some embodiments of the present disclosure, in order to suppress defects such as fracture of the separator or exposure of the electrode plate due to interference between the core portion and a welding rod, an optimized shape of the reform pin 400 that may increase the shortened length of the core portion may be provided.

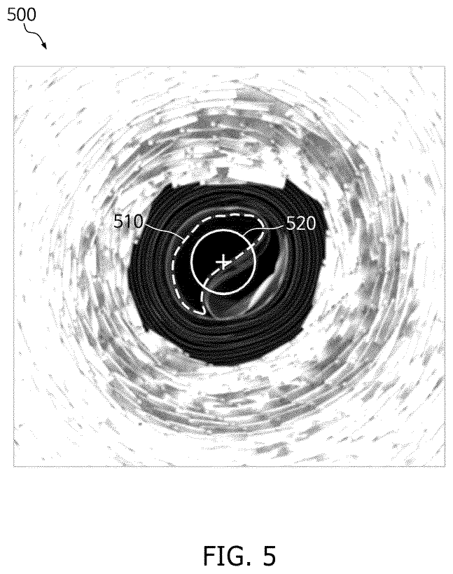

FIG. 5 illustrates an example of a defect in a core portion of an electrode assembly that may occur before reforming.

Referring to FIG. 5, during the manufacturing process of the secondary battery, a phenomenon may occur in which a core portion of an electrode assembly is partially unwound due to shaking of the wound electrode assembly over time or during the process of inserting the wound electrode assembly into the case. This allows some of the separator, the first electrode, and the second electrode positioned in the core portion of the electrode assembly to be disposed across the central axis of the electrode assembly. For example, in a defect that occurs before reforming, the central hole 510 of the electrode assembly may have a narrower area than the cross-section 520 of a terminal welding rod, or may overlap the cross-section 520 of the terminal welding rod.

The manufacturing process of the secondary battery may include a step of inserting the terminal welding rod through the central hole 510 of the electrode assembly, after the electrode assembly is embedded in the case. Therefore, in a case where some of the separator, the first electrode, and the second electrode is disposed across the central axis of the electrode assembly, some of the separator, the first electrode, and the second electrode may be broken by the terminal welding rod penetrating the central hole 510. This breakage may cause a short circuit in manufactured secondary batteries. Herein, the insertion of the terminal welding rod may be for the purpose of welding the electrode assembly and the current collector plate positioned on one side of the case.

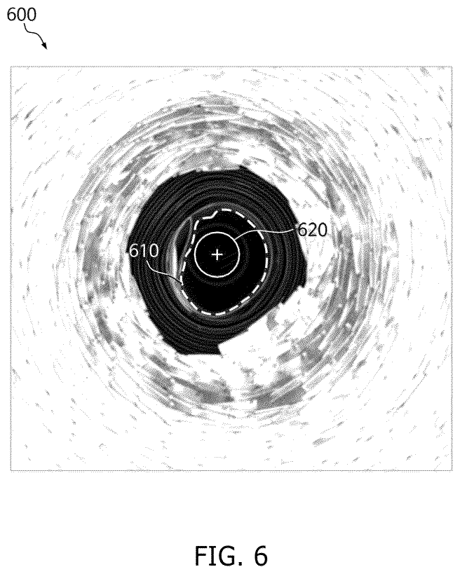

FIG. 6 illustrates an example of a core portion of an electrode assembling improved according to an embodiment of the present disclosure.

Referring to FIG. 6, some of the separator, the first electrode, and the second electrode may not be disposed across the central axis of the electrode assembly in the core portion of the electrode assembly improved according to an embodiment of the present disclosure. For example, the central hole 610 of the electrode assembly improved according to an embodiment of the present disclosure may have a wider area than the cross section 620 of the terminal welding rod. Therefore, some of the separators, the first electrodes, and the second electrodes forming the outer wall of the central hole 610 are not broken even in a case where the terminal welding rod penetrates the central hole 610.

FIG. 7 to FIG. 9 illustrate data of a shortened length of a core portion of an electrode assembly according to an outer diameter of a reform pin according to an embodiment of the present disclosure.

The outer diameter (or diameter) of the reform pin according to an embodiment of the present disclosure may be 80% to 90% of the diameter (or short axis) of the central hole of the electrode assembly. For example, in a case where the diameter (or short axis) of the central hole of the electrode assembly is 5 mm, the diameter of the reform pin may be 4.26 mm to 4.34 mm.

Referring to FIG. 7, in a case where the diameter of the reform pin is 4.25 mm or less (701), it is easy to insert the reform pin into the central hole of the electrode assembly, and in most of the data, it can be confirmed that the short axis length of the central hole after reforming also increases compared to the short axis length of the central hole before reforming. However, in some data, it can be confirmed that the short axis length of the central hole after reforming does not increase compared to the short axis length of the central hole before reforming, and it can also be confirmed that there is data in which a defect occurred because the short axis length of the central hole after reforming did not increase sufficiently.

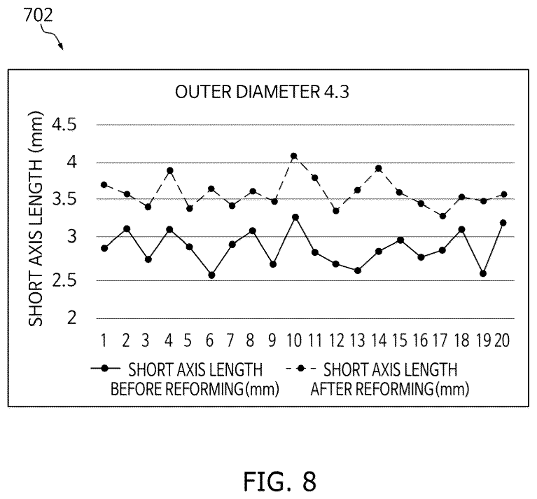

Referring to FIG. 8, in a case where the diameter of the reform pin is 4.3 mm (702), it is easy to insert the reform pin into the central hole of the electrode assembly, and it can be confirmed that the short axis length of the central hole after reforming increases compared to the short axis length of the central hole before reforming in all data.

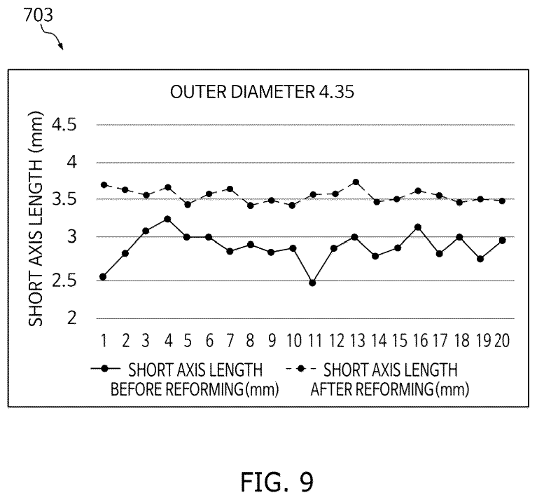

Referring to FIG. 9, in a case where the diameter of the reform pin is 4.3 mm or more (703), it can be confirmed that the short axis length of the central hole after reforming increases compared to the short axis length of the central hole before reforming in all data. However, the difference in size between the central hole of the electrode assembly and the diameter of the reform pin is small, so that it may not be easy to insert the reform pin into the central hole of the electrode assembly. For example, in a case where the reform pin is inserted at high speed into the central hole of the electrode assembly, it may be confirmed that defects due to pressure load occur in some data.

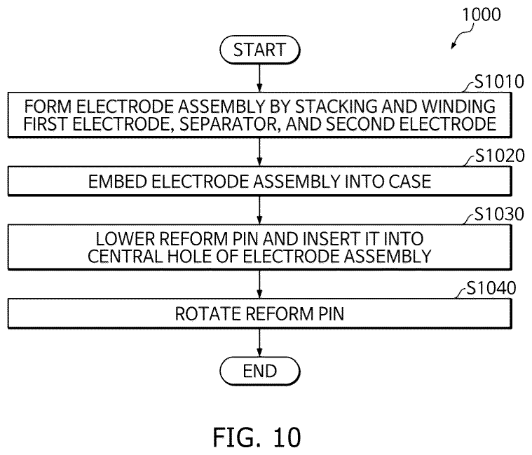

FIG. 10 illustrates a flowchart of an example of a method for manufacturing a secondary battery according to the present disclosure.

Referring to FIG. 10, a method 1000 for manufacturing a secondary battery according to an embodiment of the present disclosure may include forming an electrode assembly by stacking and winding a first electrode, a separator, and a second electrode (S1010).

Thereafter, the electrode assembly may be embedded in the case (S1020). According to the embodiment, the diameter of the case may be 45 mm to 47 mm.

Then, the reform pin may be lowered and inserted into the central hole of the electrode assembly (S1030). Herein, the reform pin may include a cylinder portion having a cylindrical shape, a tapered portion formed at one end of the cylinder portion, and a connecting portion connecting the cylinder portion and the tapered portion. According to the embodiment, the length of the reform pin inserted into the electrode assembly may be 60% to 95% of the length of the electrode assembly. For example, the length of the reform pin inserted into the electrode assembly may be 60 mm to 70 mm.

According to an embodiment of the present disclosure, the diameter of the reform pin may be 80% to 90% of the diameter of the central hole. Herein, the diameter of the central hole may be 12% to 15% of the diameter of the electrode assembly. For example, the diameter of the reform pin may be 4.26 mm and 4.34 mm.

According to an embodiment of the present disclosure, the length of the tapered portion may be 15% to 45% of the length of the electrode assembly. For example, the length of the tapered portion can be 28 mm to 32 mm.

According to an embodiment of the present disclosure, the connecting portion may be fillet-processed. For example, the connecting portion may be fillet-processed with a radius of curvature of 10 mm to 20 mm.

According to the embodiment, the lowering the reform pin and inserting the reform pin into the central hole of the electrode assembly (S1030) may include measuring the air pressure in the case through the floating sensor portion.

Thereafter, the reform pin may be rotated (S1040). According to the embodiment, rotating of the reform pin (S1040) may include driving the rotating portion to rotate the reform pin at a speed of 1000 rpm to 1499 rpm. Herein, the rotating portion may be driven to rotate three or more times after the reform pin is inserted into the central hole.

The method 1000 for manufacturing the secondary battery according to an embodiment of the present disclosure may further include inserting the terminal welding rod through the central hole of the electrode assembly. For example, the electrode assembly may be welded to be electrically connected to the current collector plate disposed at the lower end of the case. The current collector plate may be electrically connected to the first electrode or the second electrode of the electrode assembly.

For example, the non-coated portion and the current collector plate of the electrode assembly may be welded using one of, e.g., ultrasonic welding, laser welding, resistance welding, tungsten inert gas (TIG) welding, or a combination thereof. The welding method may be any suitable welding method of two materials.

The secondary battery manufactured according to an embodiment of the present disclosure may include a lithium battery cell, a sodium battery cell, and the like. However, the secondary battery may also include all batteries capable of repeatedly providing electricity through charging and discharging. The secondary battery according to an embodiment may be applied to automobiles, mobile phones, and/or various types of electrical devices.

According to some embodiments of the present disclosure, by improving the reform molding process that lowers and opens the entrance of the core portion before inserting the terminal welding rod, a new reform molding process may be provided in which the reform pin is lowered and rotated to expand the core portion and maintain its shape.

The methods, processes, and/or operations described herein may be performed by code or instructions to be executed by a computer, processor, controller, or other signal processing device. For example, the controllers controlling the driving portion 140 and the rotating portion 150 may be a computing device, e.g., a workstation computer, a desktop computer, a laptop computer, a tablet computer, or the like, and may be implemented as a simple controller, a complex processor, e.g., a microprocessor, a central processing unit (CPU), a graphics processing unit (GPU) etc., or a processor composed of software, dedicated hardware or firmware, or the like. The computer, processor, controller, or other signal processing device may be those described herein or one in addition to the elements described herein.

By way of summation and review, in an electrode assembly wound in a secondary battery, a core winding of the electrode assembly may become partially unwound over time or when the electrode assembly is inserted into a case. Such a partial unwound core may cause a separator breakage or an exposure of the electrode plates due to interference between the core and the welding rod.

In contrast, according to embodiments of the present disclosure, by inserting and rotating a reform pin into a central hole of the electrode assembly, it is possible to correct a defect in which the core portion of the electrode assembly wound during the manufacturing process of a secondary battery becomes partially unwound over time or during the process of inserting the wound electrode assembly into the case.

According to some embodiments of the present disclosure, by improving the reform molding process that simply lowered and opened the entrance of the core portion before inserting the terminal welding rod, a new reform molding process may be provided in which the reform pin is lowered and rotated to expand the core portion and maintain its shape.

According to some embodiments of the present disclosure, in order to suppress defects such as fracture of the separator or exposure of the electrode plate due to interference between the core portion and the welding rod, an optimized shape of a reform pin that may increase the shortened length of the core portion may be provided.

However, aspects and features of the present disclosure are not limited to those described above, and other aspects and features not mentioned will be clearly understood by a person skilled in the art from the detailed description, described above.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A system for manufacturing a secondary battery, the system comprising:
a reform pin insertable into a central hole of an electrode assembly, the electrode assembly including a wound stack of a first electrode, a separator, and a second electrode;
a driver configured to move the reform pin and to insert the reform pin into the central hole, after the electrode assembly is embedded in a case; and
a rotator configured to rotate the reform pin.

2. The system for manufacturing the secondary battery as claimed in claim 1, wherein the reform pin includes a cylinder portion having a cylindrical shape, a tapered portion at one end of the cylinder portion, and a connecting portion connecting the cylinder portion and the tapered portion.

3. The system for manufacturing the secondary battery as claimed in claim 2, wherein a length of the tapered portion is 35% to 45% of a length of the electrode assembly.

4. The system for manufacturing the secondary battery as claimed in claim 2, wherein a length of the tapered portion is 28 mm to 32 mm.

5. The system for manufacturing the secondary battery as claimed in claim 2, wherein the connecting portion has curved edges.

6. The system for manufacturing the secondary battery as claimed in claim 5, wherein the connecting portion has a radius of curvature of 10 mm to 20 mm.

7. The system for manufacturing the secondary battery as claimed in claim 1, wherein a length of the reform pin is 60% to 95% of a length of the electrode assembly.

8. The system for manufacturing the secondary battery as claimed in claim 1, wherein a length of the reform pin is 60 mm to 70 mm.

9. The system for manufacturing the secondary battery as claimed in claim 1, wherein a diameter of the reform pin is 80% to 90% of a diameter of the central hole.

10. The system for manufacturing the secondary battery as claimed in claim 1, wherein a diameter of the central hole is 12% to 15% of a diameter of the electrode assembly.

11. The system for manufacturing the secondary battery as claimed in claim 1, wherein a diameter of the reform pin is 4.26 mm to 4.34 mm.

12. The system for manufacturing the secondary battery as claimed in claim 1, wherein the rotator is configured to rotate the reform pin at a speed of 1000 rpm to 1499 rpm.

13. The system for manufacturing the secondary battery as claimed in claim 1, wherein the rotator is configured to rotate three or more times after the reform pin is inserted into the central hole.

14. The system for manufacturing the secondary battery as claimed in claim 1, further comprising a floating sensor configured to measure air pressure inside the case.

15. The system for manufacturing the secondary battery as claimed in claim 1, wherein a diameter of the case is 45 mm to 47 mm.

16. A method for manufacturing a secondary battery, the method comprising:
forming an electrode assembly by stacking and winding a first electrode, a separator, and a second electrode;
embedding the electrode assembly into a case;
lowering a reform pin toward a central hole of the electrode assembly and inserting the reform pin into the central hole of the electrode assembly; and
rotating the reform pin.

17. The method for manufacturing the secondary battery as claimed in claim 16, further comprising inserting a terminal welding rod through the central hole of the electrode assembly.

18. The method for manufacturing the secondary battery as claimed in claim 16, wherein the reform pin is formed to include a cylinder portion having a cylindrical shape, a tapered portion formed at one end of the cylinder portion, and a connecting portion connecting the cylinder portion and the tapered portion.

19. The method for manufacturing the secondary battery as claimed in claim 16, wherein a length of the reform pin inserted into the electrode assembly is formed to be 60% to 95% of a length of the electrode assembly.

20. The method for manufacturing the secondary battery as claimed in claim 16, wherein rotating the reform pin includes driving a rotator to rotate the reform pin at a speed of 1000 rpm to 1499 rpm.
